(19) United States
(12) Patent Application Publication
(10) Pub. No.: US 2025/0378241 A1
(43) Pub. Date: Dec. 11, 2025

(54) MODELING METHOD FOR PRECIPITATION PREDICTION MODEL, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Yixiong XIAO, Beijing (CN); Chenggang XIE, Beijing (CN); Jingbo ZHOU, Beijing (CN)

(73) Assignee: BEIJING BAIDU NETCOM SCIENCE TECHNOLOGY CO., LTD., Beijing (CN)

(21) Appl. No.: 19/300,431

(22) Filed: Aug. 14, 2025

(30) Foreign Application Priority Data
Jun. 19, 2025 (CN) 202510828105.4

(51) Int. Cl. G06F 30/27

(52) U.S. Cl. CPC G06F 30/27

(57) ABSTRACT

The present disclosure provides a modeling method for precipitation prediction model. The specific scheme is: obtaining circulation variable information of a specified region in each time period of at least two time periods before a specified time moment based on reanalysis results of a weather forecast center; obtaining observed precipitation of the specified region in a next time period after the specified time moment based on a pre-collected observation dataset of the specified region; training a precipitation prediction model of the specified region based on the circulation variable information of the specified region in each time period of at least two time periods before the specified time moment and the observed precipitation of the specified region in the next time period after the specified time moment.

The present application claims the priority of Chinese Patent Application No. 202510828105.4, filed on Jun. 19, 2025. The disclosure of the above application is incorporated herein by reference in its entirety.

### FIELD OF THE DISCLOSURE

The present disclosure relates to the field of computer technology, and particularly to a modeling method for precipitation prediction model, an electronic device, and a storage medium.

### BACKGROUND OF THE DISCLOSURE

For some regions with complex climate conditions and dense population and industry, drought and flood disasters have a huge impact on their economic construction and social development. Therefore, seasonal time-scale prediction of summer drought and flood is extremely critical, concerning national economy and people's livelihood, and is also a focus of national disaster prevention and mitigation work.

### SUMMARY OF THE DISCLOSURE

The present disclosure provides a modeling method for precipitation prediction model, an electronic device, and a storage medium.

According to one aspect of the present disclosure, a modeling method for precipitation prediction model is provided, including:
obtaining circulation variable information of a specified region in each time period of at least two time periods before a specified time moment based on a reanalysis result of a weather forecast center;
obtaining an observed precipitation of the specified region in a next time period after the specified time moment based on a pre-collected observation dataset of the specified region;
training a precipitation prediction model of the specified region based on the circulation variable information of the specified region in each time period of at least two time periods before the specified time moment and the observed precipitation of the specified region in the next time period after the specified time moment.

According to another aspect of the present disclosure, there is provided an electronic device, including:
at least one processor; and
a memory communicatively connected with the at least one processor;
wherein the memory stores instructions executable by the at least one processor, and the instructions are executed by the at least one processor to enable the at least one processor to perform a modeling method for precipitation prediction model, wherein the modeling method for precipitation prediction model includes:
obtaining circulation variable information of a specified region in each time period of at least two time periods before a specified time moment based on reanalysis results of a weather forecast center;
obtaining an observed precipitation of the specified region in a next time period after the specified time moment based on a pre-collected observation dataset of the specified region;
training a precipitation prediction model of the specified region based on the circulation variable information of the specified region in each time period of at least two time periods before the specified time moment and the observed precipitation of the specified region in the next time period after the specified time moment.

According to yet another aspect of the present disclosure, there is provided a non-transitory computer readable storage medium with computer instructions stored thereon, wherein the computer instructions are used for causing a modeling method for precipitation prediction model, wherein the modeling method for precipitation prediction model includes:
obtaining circulation variable information of a specified region in each time period of at least two time periods before a specified time moment based on reanalysis results of a weather forecast center;
obtaining observed precipitation of the specified region in a next time period after the specified time moment based on a pre-collected observation dataset of the specified region;
training a precipitation prediction model of the specified region based on the circulation variable information of the specified region in each time period of at least two time periods before the specified time moment and the observed precipitation of the specified region in the next time period after the specified time moment.

It should be understood that the content described in this section is not intended to identify key or essential features of the present embodiments of the present disclosure, nor is it intended to limit the scope of the present disclosure. Other features of the present disclosure will become readily understandable through the following specification.

### BRIEF DESCRIPTION OF DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a block diagram of an electronic device for implementing the method of the present embodiments of the present disclosure.

### DETAILED DESCRIPTION OF PREFERRED EMBODIMENTS

The following description of exemplary embodiments of the present disclosure is made with reference to the drawings, which includes various details of the present embodiments to aid in understanding, and should be considered merely exemplary. Therefore, those skilled in the art should recognize that various changes and modifications can be made to the present embodiments described herein without departing from the scope and spirit of the present disclosure. Similarly, for clarity and conciseness, description of known functions and structures is omitted in the following description.

Obviously, the described embodiments are only a part of the present embodiments of the present disclosure, not all of the present embodiments. All other embodiments obtained by those skilled in the art without creative effort based on the present embodiments of the present disclosure shall fall within the protection scope of the present disclosure.

It should be noted that the terminal devices involved in the present embodiments of the present disclosure may include but are not limited to mobile phones, Personal Digital Assistants (PDA), wireless handheld devices, tablet computers and other smart devices; Display devices may include but are not limited to personal computers, televisions and other devices with display functions.

Furthermore, the term “and/or” in this document is merely a description of association relationship of associated objects, indicating that three relationships may exist. For example, A and/or B may indicate: A exists alone, both A and B exist, and B exists alone. In addition, the character “/” in this document generally indicates an “or” relationship between the associated objects before and after it.

For seasonal precipitation prediction of any specified region, a statistical forecasting method can be used to achieve precipitation prediction. Specifically, by selecting factors that affect flood-season precipitation in the specified region, a statistical forecasting model is established, and then the statistical forecasting model is used for precipitation prediction.

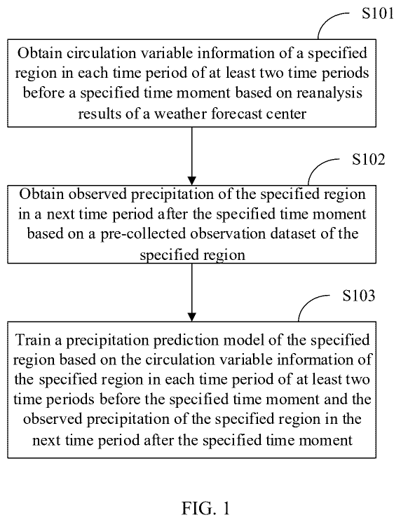

FIG. 1 is a schematic diagram according to a first embodiment of the present disclosure; As shown in FIG. 1, the present embodiment provides a modeling method for precipitation prediction model, which specifically may include the following steps of:

S101: Obtaining circulation variable information of a specified region in each time period of at least two time periods before a specified time moment based on reanalysis results of a weather forecast center;

An execution subject of the modeling method for precipitation prediction model in the present embodiment can be a modeling apparatus for precipitation prediction model, and the apparatus can be an electronic entity, or can also be a software-integrated disclosure.

The weather forecast center in the present embodiment can be the European Centre for Medium-Range Weather Forecasts (ECMWF), and ECMWF can provide global meteorological data for scientific research, climate modeling, and weather forecasting, etc.

In the present embodiment, data can be pre-ordered from ECMWF, and then the reanalysis results can be received from the weather forecast center. In practical applications, data can also be ordered from other weather forecast centers to obtain corresponding reanalysis results.

In practical applications, real-time weather data can be obtained from the reanalysis results of ECMWF, and weather data for any specified region during historical periods can also be obtained from ECMWF. Of course, the historical periods here refer to periods that ECMWF has already collected and stored.

In practical applications, the data in the reanalysis results from the weather forecast center identifies geographical locations by longitude and latitude, and the longitude and the latitude can be precise to 1 degree. As for the selection of data for the specified region, the data for the specified region can be obtained by referring to the longitude and the latitude of the specified region.

The circulation variable information in the present embodiment can include a name of circulation variables, namely field names, and can also include values corresponding to the fields. The circulation variables used in the present embodiment specifically refer to circulation variables related to precipitation.

In the present embodiment, the circulation variable information obtained based on the reanalysis results of the weather forecast center can be original data from the weather forecast center, or data obtained through simple inference calculations based on the original data from the weather forecast center. In any case, the accuracy and the reliability of the obtained circulation variable information can be effectively ensured.

S102: Obtaining an observed precipitation of the specified region in a next time period after the specified time moment based on a pre-collected observation dataset of the specified region;

The observed precipitation in the present embodiment refers to the actual precipitation data observed locally in the specified region at various historical moments. In the present embodiment, professional monitoring tools can be used to monitor precipitation in each time period of the specified region and generate an observation dataset for the specified region. When in use, obtaining the observed precipitation of the specified region in the next time period after the specified time moment from the observation dataset of the specified region can ensure the accuracy and the validity of the obtained key precipitation data.

S103: Training a precipitation prediction model of the specified region based on the circulation variable information of the specified region in each time period of at least two time periods before the specified time moment and the observed precipitation of the specified region in the next time period after the specified time moment.

In the present embodiment, the accuracy of circulation variable information obtained from ECMWF is very high, and the data from a locally observed precipitation dataset is also authentic and valid. Therefore, training the precipitation prediction model of the specified region using the circulation variable parameters of the specified region in each time period of at least two time periods before the specified time moment obtained from ECMWF, and the observed precipitation of the specified region in the next time period after the specified time moment obtained based on the observation dataset, can effectively ensure an accuracy of training data sources, thereby effectively improving an accuracy of the trained precipitation prediction model.

The length of the time period in the present embodiment is a time-scale. The length can be set according to experience or requirements, for example, the length can be one month, one week, or the length can be one week, one day or several hours. In other words, according to an implementation principle of the present embodiment, precipitation prediction models for forecast periods of various time-scales can be modeled.

The precipitation prediction model of the present embodiment obtains circulation variable information of the specified region in each time period of at least two time periods before the specified time moment through the weather forecast center, which can fully ensure the accuracy and the reliability of the circulation variable information. Obtaining the observed precipitation of the specified region in the next time period after the specified time moment through the observation dataset can fully ensure an authenticity of the first observed precipitation data. Therefore, when training the precipitation prediction model of the specified region using the obtained circulation variable information of the specified region in each time period of at least two time periods before the specified time moment and the observed precipitation of the specified region in the next time period after the specified time moment, an accuracy of the trained precipitation prediction model can be effectively improved.

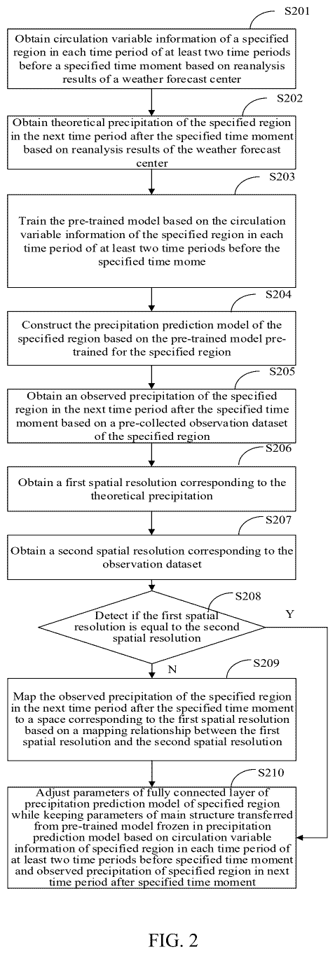

FIG. 2 is a schematic diagram according to a second embodiment of the present disclosure; The modeling method for precipitation prediction model of the present embodiment, based on a technical solution of the present embodiment shown in FIG. 1, further describes the technical solution of the present disclosure in more detail. As shown in FIG. 2, the modeling method for precipitation prediction model of the present embodiment specifically includes the following steps of:

S201: Obtaining circulation variable information of a specified region in each time period of at least two time periods before a specified time moment based on reanalysis results of a weather forecast center;

A specific implementation of the step is the same as step S101 of the present embodiment shown in FIG. 1.

For example, Table 1 below shows some circulation variables provided in the present embodiment:

TABLE 1

| Variable Type | Circulation Factor | Variable Altitude |
|---|---|---|
| Pressure-level | Zonal wind field(u) | 200 hPa, 850 hPa |
| | Meridional wind field(v) | 200 hPa, 850 hPa |
| | Specific humidity field (q) | 850 hPa |
| | Temperature field | 850 hPa |
| | Geopotential height | 200 hPa, 500 hPa |
| Single-level | Temperature at 2 m | — |
| | Mean sea level pressure | — |

As shown in Table 1, the circulation variables in the present embodiment can include pressure-level and single-level variables. For example, pressure-level circulation variables can include at least one of a zonal wind field, a meridional wind field, a specific humidity field, a temperature field, and a geopotential height corresponding to each preset pressure altitude among at least two preset pressure altitudes (such as 200 hPa, 850 hPa, etc.). Single-level circulation variables can include at least one of a temperature at a specified height such as 2 m and mean sea level pressure.

The specified region in the present embodiment can be defined based on its longitude and latitude. For example, for the Yangtze River Basin region, a focus can be on an area within longitude 70° E-140° E and latitude 15°N-45°N, which can cover the Yangtze River Basin and its associated circulation influence areas.

In the present embodiment, the above circulation variable information used is very rich, which can provide effective data support for training the precipitation prediction model, thereby effectively improving the accuracy of the trained precipitation prediction model.

S202: Obtaining theoretical precipitation of the specified region in the next time period after the specified time moment based on reanalysis results of the weather forecast center;

Similarly, the weather forecast center in the present embodiment can also be ECMWF. From ECMWF's reanalysis results, a theoretical precipitation for any historical time period of the specified region can also be accurately analyzed. Since this precipitation is derived from theoretical analysis by the weather forecast center, rather than observed in the specified region, the precipitation is called theoretical precipitation.

Additionally, the reanalysis results from the weather forecast center do not directly identify arbitrary regions, but rather mark data such as circulation variable information and precipitation by grid points, with each grid point corresponding to a range of longitude and latitude. For example, each grid point can identify a 1°×1° grid.

For a specified region, such as the Yangtze River Basin, a boundary polygon can be constructed based on its boundary shapefile. Then, all grid points near the obtained polygon are traversed and whether the center of each grid point is within the polygon range is judged in sequence. This judgment process can use a ray method, that is, drawing an arbitrary ray from the current grid point center and counting the number of intersections with the polygon boundary. If the number of intersections is odd, the grid point is determined to be inside the polygon and saved to an array; Otherwise, the grid point is determined to be outside the polygon. Finally, since some coastal grid points may have data default issues due to their centers being located on a sea surface, even if these grid points are within the Yangtze River Basin area, the grid points need to be screened and filtered out to ensure that the final grid point data obtained within the specified region is complete and meets requirements.

Then, data for the specified region is obtained based on the data of all grid points included in the specified region. For example, certain mathematical operations such as averaging can be performed on the circulation variable information of each grid point in the specified region to obtain circulation variable information for the specified region. Similarly, certain mathematical operations such as summation can be performed on the theoretical precipitation of each grid point in the specified region to obtain theoretical precipitation for the specified region.

Correspondingly, in order to obtain the values of each circulation variable for each time period in the specified region, the value of that circulation variable for each grid point included in the specified region during that time period is first obtained based on the reanalysis results from the weather forecast center, then an average of the circulation variable values of all grid points included in the specified region during that time period is taken as the value of that circulation variable for the specified region during that time period. In this way, values for each circulation variable in the specified region can be obtained for each time period.

Correspondingly, in order to obtain the theoretical precipitation for the specified region during each time period, the theoretical precipitation for each grid point included in the specified region during that time period is first obtained based on the reanalysis results from the weather forecast center; Then the theoretical precipitation of all grid points included in the specified region during that time period is summed up as the theoretical precipitation for the specified region during that time period.

In the above-described way, the circulation variable information of the specified region in each time period of at least two time periods before the specified time moment can be accurately obtained; The theoretical precipitation of the specified region in the next time period after the specified time moment can also be accurately obtained.

The data obtained in the present embodiment is used for model training, and all the obtained data are historical data, including the next time period after the specified time moment. Therefore, with this step, it can accurately obtain the theoretical precipitation of the specified region in the next time period after the specified time moment.

Optionally, before step S201, the method may further include: obtaining reanalysis results from ECMWF, then selecting data of precipitation-related circulation variables from the reanalysis results; and performing preprocessing, such as noise removal, standardization processing and unit conversion, etc., which is not limited herein.

S203: Training the pre-trained model based on the circulation variable information of the specified region in each time period of at least two time periods before the specified time moment and the theoretical precipitation of the specified region in the next time period after the specified time moment;

Using the circulation variable information of the specified region in each time period of at least two time periods before the specified time moment and the theoretical precipitation of the specified region in the next time period after the specified time moment as training data, multiple similar training data are collected to build a training set and train the pre-trained model. The circulation variable information of the specified region in each time period of at least two time periods before the specified time moment serves as input, and the theoretical precipitation of the specified region in the next time period after the specified time moment serves as supervision labels. For example, during training, the circulation variable information of the specified region in each time period of at least two time periods before the specified time moment can be input into the pre-trained model, and the pre-trained model can predict the predicted precipitation of the specified region in the next time period after the specified time moment based on the input information; Then a loss function for the pre-trained model is constructed based on the predicted precipitation and the theoretical precipitation, and the parameters of the pre-trained model are adjusted based on the loss function to make the loss function converge. The pre-trained model is trained using multiple similar training data.

After the pre-trained model is trained in the above manner and the training is completed, the pre-trained model can also be validated using a validation set and tested using a test set.

In the present embodiment, the collected training set can select data from ECMWF from 1991-2011, correspondingly, the validation set can select data from 2012-2016, and the test set can select data from 2017-2021. In terms of data organization and processing, a three-month sliding window strategy can be used to select seasonal samples, where the circulation variable input for each season is an average of three months, and precipitation is the cumulative sum of precipitation over three months. Two loss functions can be used when training the pre-trained model: a Mean Squared Error (MSE) function and a cosine distance function, and the two loss functions are weighted and combined in a certain proportion, namely Loss=L_{MSE}+αL_{cos}, where

$${L}_{cos} = 1 - \frac{\vec{x} \cdot \vec{y}}{‖ \vec{x} ‖ ‖ \vec{y} ‖} ,$$

α is a weight parameter, and experiments show that when a is 1, a prediction effect is better. MSE loss is a necessary loss function in regression prediction, but with MSE loss alone, model optimization will fall into local optimal solutions, meaning the model tends to predict an optimal solution applicable to every year. For example, the model will predict similar results for different inputs each year, and achieve relatively good results in numerical prediction for each year. However, spatial distribution cannot be correctly predicted. Adding the cosine distance function enhances a model's ability to fit spatial patterns.

In the present embodiment, the circulation variable information of the specified region in each time period of at least two time periods before the specified time moment and the theoretical precipitation of the specified region in the next time period after the specified time moment are all obtained based on the reanalysis results from the weather forecast center, which can fully ensure an authenticity and a reliability of the training data, thereby effectively improving an accuracy of the pre-trained model.

The pre-trained model in the present embodiment adopts an innovative dual-module architecture, combining an adapter module and an improved Residual Network (ResNet) 50, aimed at effectively processing meteorological circulation data and improving an accuracy of precipitation prediction.

An adapter module includes a 3×3 convolutional layer, Batch Normalization (BN), and a Convolutional Block Attention Module (CBAM), specifically including three repetitions of the above structure. The 3×3 convolutional layer maintains feature map dimensions unchanged; and BN accelerates training convergence; The CBAM can utilize a dual mechanism of channel attention and spatial attention to obtain channel statistical information from global average/maximum pooling and learn spatial importance after pooling along channel dimensions and convolution, achieving joint modeling of spatial and channel features.

ResNet50: loads ImageNet pre-trained weights and replaces fully connected layers to adapt to a precipitation prediction task.

During training, parameters in ResNet50 except for the fully connected layers are frozen to preserve an underlying feature extraction capability and prevent overfitting on small data, while keeping the adapter in a trainable state to learn how to adapt meteorological data to a ResNet feature space.

An overall workflow of the pre-trained model is: inputting data first goes through the adapter for feature transformation and enhancement, then entering the ResNet50 network with pre-trained weights for deep feature extraction, and finally outputting prediction results through the fully connected layer.

During training, the data stream is standardized and then passes through the feature enhancement of the adapter, the deep feature extraction of ResNet50 and the precipitation prediction of the fully connected layer. The entire system is trained end-to-end, combining advantages of a CBAM attention mechanism's feature alignment enhancement, a transfer learning capability of pre-trained models, and an anti-overfitting effect of a parameter freezing strategy, making the system particularly suitable for processing meteorological circulation data with spatial correlation.

The pre-trained model trained in the present embodiment is trained using data in the reanalysis results of the weather forecast center, which has very strong universality, and can be applied to precipitation prediction for any specified region globally.

S204: Constructing the precipitation prediction model of the specified region based on the pre-trained model pre-trained for the specified region;

For example, when implementing the step specifically, the step may include the following steps:
(1) Transferring the main structure of the pre-trained model of the specified region to the precipitation prediction model of the specified region as the main structure of the precipitation prediction model of the specified region;
(2) Constructing the fully connected layer of the precipitation prediction model of the specified region.

The precipitation prediction model in the present embodiment transfers the main structure from the pre-trained model, meaning that the precipitation prediction model also includes the adapter module and ResNet50. A difference is that the fully connected layer is different from that of the pre-trained model, and adaptive training of the fully connected layer of the precipitation prediction model is needed before use.

In the present embodiment, transferring the main structure of the pre-trained model as the main structure of the precipitation prediction model can effectively reduce the construction cost of the precipitation prediction model, improve an accuracy of the constructed precipitation model, and also reduce a subsequent training cost of the precipitation prediction model and improve training efficiency.

S205: Obtaining an observed precipitation of the specified region in the next time period after the specified time moment based on a pre-collected observation dataset of the specified region;

The observation dataset in the present embodiment is based on real data collected locally in the specified region, which is more accurate than the theoretical precipitation of the specified region in the next time period after the specified time moment obtained in step S202.

S206: Obtaining a first spatial resolution corresponding to the theoretical precipitation;

For example, when obtaining theoretical precipitation of the specified region based on ECMWF's reanalysis results, all grid point data can be uniformly interpolated to a 1°×1° grid. That is, the corresponding first spatial resolution is 1°×1°, meaning each grid occupies 1 degree in both longitude and latitude.

S207: Obtaining a second spatial resolution corresponding to the observation dataset;

The observation dataset in the present embodiment can use CN05.1 gridded precipitation data, which has a spatial resolution of 0.25°×0.25°, meaning each grid occupies 0.25 degrees in both longitude and latitude.

S208: Detecting whether the first spatial resolution is equal to the second spatial resolution; if not equal, executing step S209; If equal, executing step S210;

S209: Mapping the observed precipitation of the specified region in the next time period after the specified time moment to a space corresponding to the first spatial resolution based on a mapping relationship between the first spatial resolution and the second spatial resolution; Executing step S210;

As in the above embodiment, the first spatial resolution corresponding to theoretical precipitation is 1°×1°, while the second spatial resolution corresponding to the observation dataset is 0.25°×0.25°. In this case, the observed precipitation can be mapped to the space corresponding to the first spatial resolution of theoretical precipitation. For example, interpolating data from four adjacent 0.25°×0.25° grid points (up, down, left, and right) into one 1°×1° grid point data, thereby obtaining unified precipitation data, enabling the transferred main structure of the precipitation prediction model to process observed precipitation more effectively, making the trained precipitation prediction model more accurate.

S210: Adjusting parameters of the fully connected layer of the precipitation prediction model of the specified region while keeping parameters of the main structure transferred from the pre-trained model frozen in the precipitation prediction model based on the circulation variable information of the specified region in each time period of at least two time periods before the specified time moment and the observed precipitation of the specified region in the next time period after the specified time moment.

In other words, during a training process of the precipitation prediction model, the main structure of the precipitation prediction model still uses the main structure of the pre-trained model with frozen parameters, and the entire training process only adjusts the parameters of the fully connected layer. A training principle is the same as that of the pre-trained model mentioned above, which will not be repeated here.

The transfer learning in the present embodiment only updates and optimizes the parameters of the fully connected layer of the precipitation prediction model, to fully utilize limited observed precipitation data and avoid overfitting risks, which can effectively reduce training difficulty and improve training effects.

Optionally, in the present embodiment, the precipitation prediction model can be used for precipitation in a rainy season (which can be in summer) of the specified region, but during training, observed precipitation throughout a year can be used for training, thereby improving a model's generalization and stability, avoiding learning from extreme samples.

Moreover, the supervision labels of the precipitation prediction model in the present embodiment are locally observed precipitation in the specified region, which are authentic and reliable data, effectively improving the accuracy of the trained precipitation prediction model.

In the field of meteorological prediction, the precipitation prediction model of the present disclosure can be used to analyze meteorological data and predict precipitation conditions, helping meteorological departments issue weather warnings in advance to reduce losses from natural disasters. Specifically, first historical meteorological data are collected, including atmospheric circulation data, temperature, humidity, etc. Then these data are cleaned and standardized to meet model input requirements. Next, the preprocessed data are used to train the model and adjust parameters to improve prediction accuracy. Afterwards, the real-time meteorological data are inputted into the trained model to generate meteorological prediction results for a future period. Finally, weather warnings are issued by the meteorological departments in advance based on these prediction results to guide the public and relevant departments to take corresponding preventive measures.

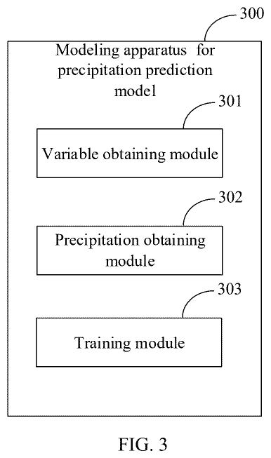

FIG. 3 is a schematic diagram according to a third embodiment of the present disclosure; As shown in FIG. 3, the present embodiment provides a modeling apparatus 300 for precipitation prediction model, including:
a variable obtaining module 301, configured to obtain circulation variable information of a specified region in each time period of at least two time periods before a specified time moment based on reanalysis results of a weather forecast center;
a precipitation obtaining module 302, configured to obtain observed precipitation of the specified region in a next time period after the specified time moment based on a pre-collected observation dataset of the specified region;
a training module 303, configured to train a precipitation prediction model of the specified region based on the circulation variable information of the specified region in each time period of at least two time periods before the specified time moment and the observed precipitation of the specified region in the next time period after the specified time moment.

An implementation principle and technical effects of the modeling apparatus 300 the precipitation prediction model in the present embodiment, through using the above modules to implement modeling of the precipitation prediction model, are the same as the implementation of the above related method embodiments, which can be referred to in detail in the above related method embodiments and will not be repeated here.

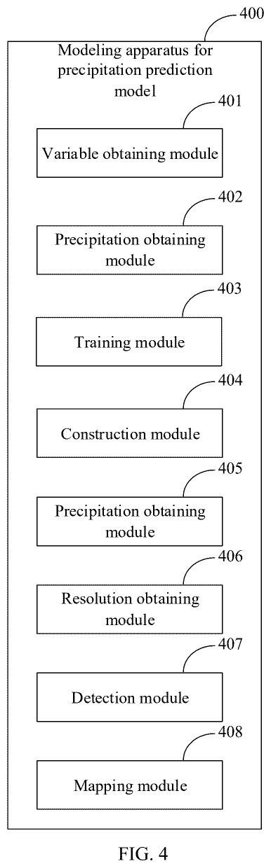

FIG. 4 is a schematic diagram according to a fourth embodiment of the present disclosure; The modeling apparatus 400 for precipitation prediction model in the present embodiment, based on the technical solution of the present embodiment shown in FIG. 3, further describes the technical solution of the present disclosure in more detail. As shown in FIG. 4, the modeling apparatus 400 for precipitation prediction model in the present embodiment includes the modules with the same names and functions as shown in FIG. 3: a variable obtaining module 401, a precipitation obtaining module 402, and a training module 403.

In the present embodiment, the circulation variable information includes: at least one of a zonal wind field, a meridional wind field, a specific humidity field, a temperature field, and a geopotential height at each pressure altitude corresponding to at least two preset pressure altitudes;

The circulation variable information further includes: at least one of a temperature at a specified height at a surface level and mean sea level pressure.

Optionally, as shown in FIG. 4, the modeling apparatus 400 for precipitation prediction model in the present embodiment further includes:
a construction module 404, configured to construct the precipitation prediction model of the specified region based on a pre-trained model pre-trained for the specified region.

Further optionally, in an embodiment of the present disclosure, the construction module 404 is configured to:
transfer the main structure of the pre-trained model of the specified region to the precipitation prediction model of the specified region as the main structure of the precipitation prediction model of the specified region;
construct a fully connected layer of the precipitation prediction model of the specified region.

Further optionally, in an embodiment of the present disclosure, the training module 403 is configured to:
adjust parameters of the fully connected layer of the precipitation prediction model of the specified region while keeping parameters of the main structure transferred from the pre-trained model frozen in the precipitation prediction model based on the circulation variable information of the specified region in each time period of at least two time periods before the specified time moment and the observed precipitation of the specified region in the next time period after the specified time moment.

Further optionally, as shown in FIG. 4, in an embodiment of the present disclosure, the modeling apparatus 400 for precipitation prediction model further includes:
a precipitation obtaining module 405, further configured to obtain theoretical precipitation of the specified region in the next time period after the specified time moment based on the reanalysis results of the weather forecast center;
a training module 404, further configured to train the pre-trained model based on the circulation variable information of the specified region in each time period of at least two time periods before the specified time moment and the theoretical precipitation of the specified region in the next time period after the specified time moment.

Further optionally, as shown in FIG. 4, in an embodiment of the present disclosure, the modeling apparatus 400 for precipitation prediction model further includes:
a resolution obtaining module 406, configured to obtain a first spatial resolution corresponding to the theoretical precipitation;
the resolution obtaining module 406 is further configured to obtain a second spatial resolution corresponding to the observation dataset;
a detection module 407, configured to detect whether the first spatial resolution is equal to the second spatial resolution;
a mapping module 408, configured to map the observed precipitation of the specified region in the next time period after the specified time moment to a space corresponding to the first spatial resolution based on a mapping relationship between the first spatial resolution and the second spatial resolution in response to the first spatial resolution being not equal to the second spatial resolution.

The implementation principle and technical effects of the modeling apparatus 400 for precipitation prediction model in the present embodiment, through using the above modules to implement modeling of the precipitation prediction model, are the same as the implementation of the above related method embodiments, which can be referred to in detail in the above related method embodiments and will not be repeated here.

In the technical solution of the present disclosure, the acquisition, storage, and disclosure of user personal information involved comply with relevant laws and regulations, and do not violate public order and good customs.

According to embodiments of the present disclosure, the present disclosure also provides an electronic device, a readable storage medium and a computer program product.

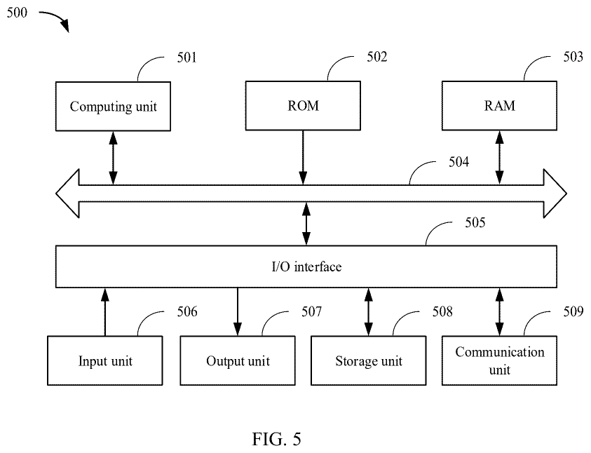

FIG. 5 shows a schematic block diagram of an example electronic device 500 that can be used to implement embodiments of the present disclosure. The electronic device is intended to represent various forms of digital computers, such as laptops, desktop computers, workstations, personal digital assistants, servers, blade servers, mainframes, and other suitable computers. The electronic device may also represent various forms of mobile devices, such as personal digital processors, cellular phones, smartphones, wearable devices, and other similar computing devices. The components shown herein, their connections and relationships, and their functions are meant merely as examples, and are not meant to limit implementations of the disclosure described and/or claimed in this document.

As shown in FIG. 5, a device 500 includes a computing unit 501, which can execute various appropriate actions and processes according to computer programs stored in a read-only memory (ROM) 502 or loaded into a random access memory (RAM) 503 from a storage unit 508. Various programs and data needed for an operation of the device 500 can also be stored in the RAM 503. The computing unit 501, the ROM 502, and the RAM 503 are connected to each other via a bus 504. An input/output (I/O) interface 505 is also connected to the bus 504.

Multiple components in the device 500 are connected to the I/O interface 505, including: an input unit 506, such as a keyboard, a mouse, etc.; an output unit 507, such as various types of displays, speakers, etc.; a storage unit 508, such as a magnetic disk, an optical disc, etc.; and a communication unit 509, such as a network card, a modem, a wireless communication transceiver, etc. The communication unit 509 allows the device 500 to exchange information/data with other devices through computer networks such as the Internet and/or various telecommunications networks.

The computing unit 501 can be various general-purpose and/or special-purpose processing components with processing and computing capabilities. Some examples of the computing unit 501 include but are not limited to a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 501 executes the various methods and processes described above, such as the above-mentioned methods of the present disclosure. For example, in some embodiments, the above-mentioned methods of the present disclosure can be implemented as computer software programs that are tangibly contained in a machine-readable medium, such as the storage unit 508. In some embodiments, part or all of a computer program can be loaded and/or installed onto the device 500 via the ROM 502 and/or the communication unit 509. When the computer program is loaded into the RAM 503 and executed by the computing unit 501, one or more steps of the above-mentioned methods of the present disclosure can be executed. Alternatively, in other embodiments, the computing unit 501 can be configured to execute the above-mentioned methods of the present disclosure through any other suitable means (for example, through firmware).

Various implementations of the systems and techniques described in this document can be realized in a digital electronic circuitry system, an integrated circuit system, a field programmable gate array (FPGA), an disclosure specific integrated circuit (ASIC), an disclosure specific standard product (ASSP), a system on chip system (SOC), a complex programmable logic device (CPLD), computer hardware, firmware, software, and/or combinations thereof. These various implementations can include implementation in one or more computer programs that are executable and/or interpretable on a programmable system including at least one programmable processor, which may be a special or general purpose programmable processor, capable of receiving data and instructions from, and transmitting data and instructions to, a storage system, at least one input device, and at least one output device.

Program code for implementing methods of the present disclosure can be written in any combination of one or more programming languages. The program code can be provided to a processor or a controller of a general-purpose computer, a special-purpose computer, or other programmable data processing apparatus, such that the program code, when executed by the processor or the controller, causes the functions/operations specified in the flowcharts and/or block diagrams to be implemented. The program code may execute entirely on the machine, partly on the machine, partly on the machine as a stand-alone software package and partly on a remote machine, or entirely on the remote machine or server.

In the context of this disclosure, a machine-readable medium may be a tangible medium that can contain or store a program for use by or in connection with an instruction execution system, an apparatus, or a device. The machine-readable medium can be a machine-readable signal medium or a machine-readable storage medium. The machine-readable medium may include, but is not limited to, an electronic, a magnetic, an optical, an electromagnetic, an infrared, or a semiconductor system, apparatus, or device, or any suitable combination thereof. More specific examples of the machine-readable storage medium would include an electrical connection based on one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof.

To provide interaction with a user, the systems and techniques described here can be implemented on a computer having a display device (e.g., a CRT (cathode ray tube) or an LCD (liquid crystal display) monitor) for displaying information to the user, and a keyboard and a pointing device (e.g., a mouse or a trackball) by which the user can provide input to the computer. Other kinds of devices can be used to provide interaction with users as well; For example, feedback provided to the user can be any form of sensory feedback (e.g., visual feedback, auditory feedback, or tactile feedback); Input from the user can be received in any form, including acoustic, speech, or tactile input.

The systems and techniques described here can be implemented in a computing system that includes a back end component (e.g., as a data server), or that includes a middleware component (e.g., an disclosure server), or that includes a front end component (e.g., a user computer having a graphical user interface or a web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computer system can include clients and servers. A client and a server are generally remote from each other and typically interact through a communication network. A relationship of client and server arises by virtue of computer programs running on the respective computers and having a client-server relationship to each other. The server can be a cloud server, or a server of a distributed system, or a server integrated with blockchain.

It should be understood that various forms of the processes shown above can be used, with steps re-ordered, added, or removed. For example, the steps recorded in this disclosure can be executed in parallel or in sequence or in different orders, as long as the steps can achieve the desired results of the technical solutions disclosed in this disclosure, which are not limited herein. The above specific embodiments do not constitute limitations to the scope of protection of this disclosure.

Those skilled in the art should understand that various modifications, combinations, sub-combinations and substitutions can be made according to design requirements and other factors. Any modifications, equivalent substitutions and improvements made within the spirit and principles of this disclosure should be included within the scope of protection of this disclosure.

What is claimed is:

1. A modeling method for precipitation prediction model, comprising:
obtaining circulation variable information of a specified region in each time period of at least two time periods before a specified time moment based on reanalysis results of a weather forecast center;
obtaining observed precipitation of the specified region in a next time period after the specified time moment based on a pre-collected observation dataset of the specified region;
training a precipitation prediction model of the specified region based on the circulation variable information of the specified region in each time period of at least two time periods before the specified time moment and the observed precipitation of the specified region in the next time period after the specified time moment.

2. The method according to claim 1, wherein the circulation variable information comprises: at least one of a zonal wind field, a meridional wind field, a specific humidity field, a temperature field, and a geopotential height at each pressure altitude corresponding to at least two preset pressure altitudes;
the circulation variable information further comprises: at least one of a temperature at a specified height at a surface level and mean sea level pressure.

3. The method according to claim 1, wherein before obtaining the circulation variable information of the specified region in each time period of at least two time periods before the specified time moment based on the reanalysis results of the weather forecast center, the method further comprises:
constructing the precipitation prediction model of the specified region based on a pre-trained model pre-trained for the specified region.

4. The method according to claim 3, wherein constructing the precipitation prediction model of the specified region based on the pre-trained model pre-trained for the specified region comprises:
transferring a main structure of the pre-trained model of the specified region to the precipitation prediction model of the specified region as a main structure of the precipitation prediction model of the specified region;
constructing a fully connected layer of the precipitation prediction model of the specified region.

5. The method according to claim 4, wherein training the precipitation prediction model of the specified region based on the circulation variable information of the specified region in each time period of at least two time periods before the specified time moment and the observed precipitation of the specified region in the next time period after the specified time moment comprises:
adjusting parameters of the fully connected layer of the precipitation prediction model of the specified region while keeping parameters of the main structure transferred from the pre-trained model frozen in the precipitation prediction model based on the circulation variable information of the specified region in each time period of at least two time periods before the specified time moment and the observed precipitation of the specified region in the next time period after the specified time moment.

6. The method according to claim 3, wherein before constructing the precipitation prediction model of the specified region based on the pre-trained model pre-trained for the specified region, the method further comprises:
obtaining theoretical precipitation of the specified region in the next time period after the specified time moment based on the reanalysis results of the weather forecast center;
training the pre-trained model based on the circulation variable information of the specified region in each time period of at least two time periods before the specified time moment and the theoretical precipitation of the specified region in the next time period after the specified time moment.

7. The method according to claim 6, wherein before training the precipitation prediction model of the specified region based on the circulation variable information of the specified region in each time period of at least two time periods before the specified time moment and the observed precipitation of the specified region in the next time period after the specified time moment, the method further comprises:
obtaining a first spatial resolution corresponding to the theoretical precipitation;
obtaining a second spatial resolution corresponding to the observation dataset;
detecting whether the first spatial resolution is equal to the second spatial resolution;
mapping the observed precipitation of the specified region in the next time period after the specified time moment to a space corresponding to the first spatial resolution based on a mapping relationship between the first spatial resolution and the second spatial resolution in response to the first spatial resolution being not equal to the second spatial resolution.

8. An electronic device, comprising:
at least one processor; and
a memory communicatively connected with the at least one processor;
wherein the memory stores instructions executable by the at least one processor, and the instructions are executed by the at least one processor to enable the at least one processor to perform a modeling method for precipitation prediction model, wherein the modeling method for precipitation prediction model comprises:
obtaining circulation variable information of a specified region in each time period of at least two time periods before a specified time moment based on reanalysis results of a weather forecast center;
obtaining observed precipitation of the specified region in a next time period after the specified time moment based on a pre-collected observation dataset of the specified region;
training a precipitation prediction model of the specified region based on the circulation variable information of the specified region in each time period of at least two time periods before the specified time moment and the observed precipitation of the specified region in the next time period after the specified time moment.

9. The electronic device according to claim 8, wherein the circulation variable information comprises: at least one of a zonal wind field, a meridional wind field, a specific humidity field, a temperature field, and a geopotential height at each pressure altitude corresponding to at least two preset pressure altitudes;
the circulation variable information further comprises: at least one of a temperature at a specified height at a surface level and mean sea level pressure.

10. The electronic device according to claim 8, wherein before obtaining the circulation variable information of the specified region in each time period of at least two time periods before the specified time moment based on the reanalysis results of the weather forecast center, the method further comprises:
constructing the precipitation prediction model of the specified region based on a pre-trained model pre-trained for the specified region.

11. The electronic device according to claim 10, wherein constructing the precipitation prediction model of the specified region based on the pre-trained model pre-trained for the specified region comprises:
transferring a main structure of the pre-trained model of the specified region to the precipitation prediction model of the specified region as a main structure of the precipitation prediction model of the specified region;
constructing a fully connected layer of the precipitation prediction model of the specified region.

12. The electronic device according to claim 11, wherein training the precipitation prediction model of the specified region based on the circulation variable information of the specified region in each time period of at least two time periods before the specified time moment and the observed precipitation of the specified region in the next time period after the specified time moment comprises:
adjusting parameters of the fully connected layer of the precipitation prediction model of the specified region while keeping parameters of the main structure transferred from the pre-trained model frozen in the precipitation prediction model based on the circulation variable information of the specified region in each time period of at least two time periods before the specified time moment and the observed precipitation of the specified region in the next time period after the specified time moment.

13. The electronic device according to claim 10, wherein before constructing the precipitation prediction model of the specified region based on the pre-trained model pre-trained for the specified region, the method further comprises:
obtaining theoretical precipitation of the specified region in the next time period after the specified time moment based on the reanalysis results of the weather forecast center;
training the pre-trained model based on the circulation variable information of the specified region in each time period of at least two time periods before the specified time moment and the theoretical precipitation of the specified region in the next time period after the specified time moment.

14. The electronic device according to claim 13, wherein before training the precipitation prediction model of the specified region based on the circulation variable information of the specified region in each time period of at least two time periods before the specified time moment and the observed precipitation of the specified region in the next time period after the specified time moment, the method further comprises:
obtaining a first spatial resolution corresponding to the theoretical precipitation;
obtaining a second spatial resolution corresponding to the observation dataset;
detecting whether the first spatial resolution is equal to the second spatial resolution;
mapping the observed precipitation of the specified region in the next time period after the specified time moment to a space corresponding to the first spatial resolution based on a mapping relationship between the first spatial resolution and the second spatial resolution in response to the first spatial resolution being not equal to the second spatial resolution.

15. A non-transitory computer readable storage medium with computer instructions stored thereon, wherein the computer instructions are used for causing a modeling method for precipitation prediction model, wherein the modeling method for precipitation prediction model comprises:
obtaining circulation variable information of a specified region in each time period of at least two time periods before a specified time moment based on reanalysis results of a weather forecast center;
obtaining observed precipitation of the specified region in a next time period after the specified time moment based on a pre-collected observation dataset of the specified region;
training a precipitation prediction model of the specified region based on the circulation variable information of the specified region in each time period of at least two time periods before the specified time moment and the observed precipitation of the specified region in the next time period after the specified time moment.

16. The non-transitory computer readable storage medium according to claim 15, wherein the circulation variable information comprises: at least one of a zonal wind field, a meridional wind field, a specific humidity field, a temperature field, and a geopotential height at each pressure altitude corresponding to at least two preset pressure altitudes;
the circulation variable information further comprises: at least one of a temperature at a specified height at a surface level and mean sea level pressure.

17. The non-transitory computer readable storage medium according to claim 15, wherein before obtaining the circulation variable information of the specified region in each time period of at least two time periods before the specified time moment based on the reanalysis results of the weather forecast center, the method further comprises:
constructing the precipitation prediction model of the specified region based on a pre-trained model pre-trained for the specified region.

18. The non-transitory computer readable storage medium according to claim 17, wherein constructing the precipitation prediction model of the specified region based on the pre-trained model pre-trained for the specified region comprises:
transferring a main structure of the pre-trained model of the specified region to the precipitation prediction model of the specified region as a main structure of the precipitation prediction model of the specified region;
constructing a fully connected layer of the precipitation prediction model of the specified region.

19. The non-transitory computer readable storage medium according to claim 18, wherein training the precipitation prediction model of the specified region based on the circulation variable information of the specified region in each time period of at least two time periods before the specified time moment and the observed precipitation of the specified region in the next time period after the specified time moment comprises:
adjusting parameters of the fully connected layer of the precipitation prediction model of the specified region while keeping parameters of the main structure transferred from the pre-trained model frozen in the precipitation prediction model based on the circulation variable information of the specified region in each time period of at least two time periods before the specified time moment and the observed precipitation of the specified region in the next time period after the specified time moment.

20. The non-transitory computer readable storage medium according to claim 17, wherein before constructing the precipitation prediction model of the specified region based on the pre-trained model pre-trained for the specified region, the method further comprises:
obtaining theoretical precipitation of the specified region in the next time period after the specified time moment based on the reanalysis results of the weather forecast center,
training the pre-trained model based on the circulation variable information of the specified region in each time period of at least two time periods before the specified time moment and the theoretical precipitation of the specified region in the next time period after the specified time moment.
